(19) United States
(12) Patent Application Publication
(10) Pub. No.: US 2015/0136796 A1
(43) Pub. Date: May 21, 2015

(54) FLAT DIE CUT INSULATED CONTAINER

(71) Applicant: Craig A. Muehlhauser, Wichita, KS (US)

(72) Inventor: Craig A. Muehlhauser, Wichita, KS (US)

(73) Assignee: The Coleman Company, Inc., Wichita, KS (US)

(21) Appl. No.: 13/502,938

(22) PCT Filed: Oct. 18, 2010
(86) PCT No.: PCT/US10/53048

§ 371 Date: Apr. 19, 2012

Related U.S. Application Data
(60) Provisional application No. 61/253,133, filed on Oct. 20, 2009.

(51) Int. Cl. B65D 81/38; B31B 1/26; B31B 1/20; B31B 1/86; B31B 1/90; G09F 3/02; B31B 1/88

(52) U.S. Cl. CPC B65D 81/3823; G09F 3/02; B31B 1/26; B31B 1/88; B31B 1/86; B31B 1/90; B31B 1/20
USPC 220/592.2; 206/459.5; 493/95; 493/56; 493/58

(57) ABSTRACT

A hard-sided cooler is formed by extruding a flat sheet of material and die cutting the materials in a specific pattern which includes panels and various fold lines; the cooler being able to be shipped efficiently and economically in its flat configuration until it reaches the distribution point where the cooler is then transformed into the assembled configuration by folding the sheet of material along the manufactured fold lines, securing the edges of the material together and then adding insulation, a liner, a handle and a lid; the cooler optionally having graphics which may be applied to the show—side of the cooler body during the extrusion process or by way of graphic inserts or wraps.

### BACKGROUND OF THE INVENTION

Insulated containers, sometimes called “coolers” are quite popular, and are used in numerous activities. Large coolers are often seen at picnics and other social gatherings, and individual users utilize smaller coolers to transport lunches to work or to maintain a beverage at a cooler temperature during a sporting activity.

Coolers may be of either the hard-sided or soft-sided variety. Hard-sided coolers are desirable because of their durability and ability to maintain food and beverages at cold temperatures for extended periods of time. Typically, the walls of contemporary hard-sided coolers include hard outer and inner shells, and an insulating central layer. The central layer is usually a product having a high insulation value, or R value, such as expanded polystyrene or polyurethane.

For most contemporary hard-sided coolers, the outer and inner layers of the insulated containers are each formed in separate vacuum, injection, or blow molding machines. The use of these machines can significantly impact and restrict manufacturing capacity. Liquid polyurethane is then manually placed between the inner and outer layers, and is permitted to expand to fill the void between the two layers. Alternatively, molded polystyrene foam is manually placed in the void between the two layers. The result is a container having smooth, hard, outer and inner surfaces, and an insulating central core. The outer layer protects the container and central core, and provides an attractive surface. The inner layer separates the central core from the contents of the container, and provides an impermeable layer so that liquids may be stored in the container.

A disadvantage to such insulated containers is the space that is needed to manufacture and to ship the containers from the location of manufacture to the point of sale. The inability to compactly and efficiently package and ship multiple containers is undesirable from an economic standpoint.

An additional disadvantage to contemporary hard-sided coolers is the difficulty or inability to apply a graphics pattern to the cooler. Consumers desire an insulated container that can be customized with graphics either of a particular sporting team or school or other aesthetically pleasing designs and colors.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

Conventional hard-sided coolers require a significant amount of floor space to manufacture, store and ship because of the pre-formed nature of the shell. Hard-sided coolers also require expensive tooling to manufacture and can create a significant amount of scrap material during the manufacturing process. In addition, the conventional urethane foam insulation can add additional expense and time during the manufacturing process in terms of tooling and energy consumption. Shipping of contemporary hard-sided coolers usually comprises lower volumes because of the volume of shipping space needed for the cooler bodies.

Conventional hard-sided coolers are available in generic, solid colors—typically red, white or blue. Many consumers would like a cooler having the advantages of a hard-sided cooler, but which also is aesthetically attractive. Personalized, interchangeable and replaceable graphics are also desirable.

In accordance with an embodiment, a cooler is provided that is formed from a single sheet of material that is die cut into a pattern which, when folded along certain grooves, allows the sheet to be formed into a container having a cavity therein. The flat cooler sheet can be easily shipped from the point of manufacture to a warehouse or to the point of distribution, display or sale where it is then folded and assembled. Insulation material and a liner can then be inserted into the cavity, a lid and a handle attached to the container, and a fully-assembled cooler is then available for sale.

In accordance with another embodiment, the cooler may be disassembled by the end-user when not in use to enable more efficient storage and then re-assembled when the end-user desires the use of a cooler.

In accordance with another embodiment, a graphic pattern may be printed onto the outside of the cooler sheet such that when folded into the assembled cooler, a specific graphic design is displayed on the exterior.

In accordance with another embodiment, a sheet of flexible material having a graphic design printed thereon may be positioned around the exterior of the cooler like a skin. One graphic skin may be removed and a replacement graphic skin may be positioned in its place to change the particular graphic design of a cooler.

In accordance with another embodiment, individual sheets of material having a graphic design printed thereon may be positioned underneath a transparent exterior of the cooler such that the graphic design is viewable from the exterior of the cooler. Replacement graphic sheets may be inserted in place of the original graphic sheets to change the exterior appearance of the cooler.

Other features of the invention will become apparent from the following detailed description when taken in conjunction with the drawings, in which:

### BRIEF DESCRIPTION OF THE DRAWINGS

FIG. 1 is a side perspective view of a cooler in accordance with an embodiment, the cooler shown in a fully assembled configuration, having a graphic design on the exterior;

FIG. 2 is a top view of the cooler of FIG. 1, shown in the unassembled, flat configuration;

FIG. 3 is a side view of the cooler of FIG. 1, shown in the unassembled, flat configuration;

FIG. 4 is a side perspective view of the cooler of FIG. 1, shown in a partially folded configuration;

FIG. 5 is a top view of the cooler of FIG. 1, shown in the fully assembled configuration;

FIG. 6 is a side view of the cooler of FIG. 1, shown in the fully assembled configuration;

FIG. 7a shows a side perspective view of a clip of the present invention;

FIG. 7b shows an end view of the clip of FIG. 7a;

FIG. 8a shows a front view of a handle button of the present invention;

FIG. 8b shows a side view of the handle button of FIG. 8b;

FIG. 9a shows a top view of a corner cap of the present invention;

FIG. 9b shows a side view of the corner cap of FIG. 9a;

FIG. 10 is a partial top perspective view of an embodiment of the cooler of the present invention, shown in a partially assembled configuration with the insulation and clip in place;

FIG. 11 is a front perspective view of an embodiment of the cooler of the present invention, shown in a partially assembled configuration with the insulation, clips, corner caps and lid in place;

FIGS. 12 and 13 are side perspective views of an embodiment of the cooler of the present invention, shown in a partially assembled configuration and showing insertion of the liner;

FIG. 14 is a front perspective view of an embodiment of the cooler of the present invention having a graphic skin; and

FIG. 15 is a front perspective view of an embodiment of the cooler of the present invention having graphic inserts.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

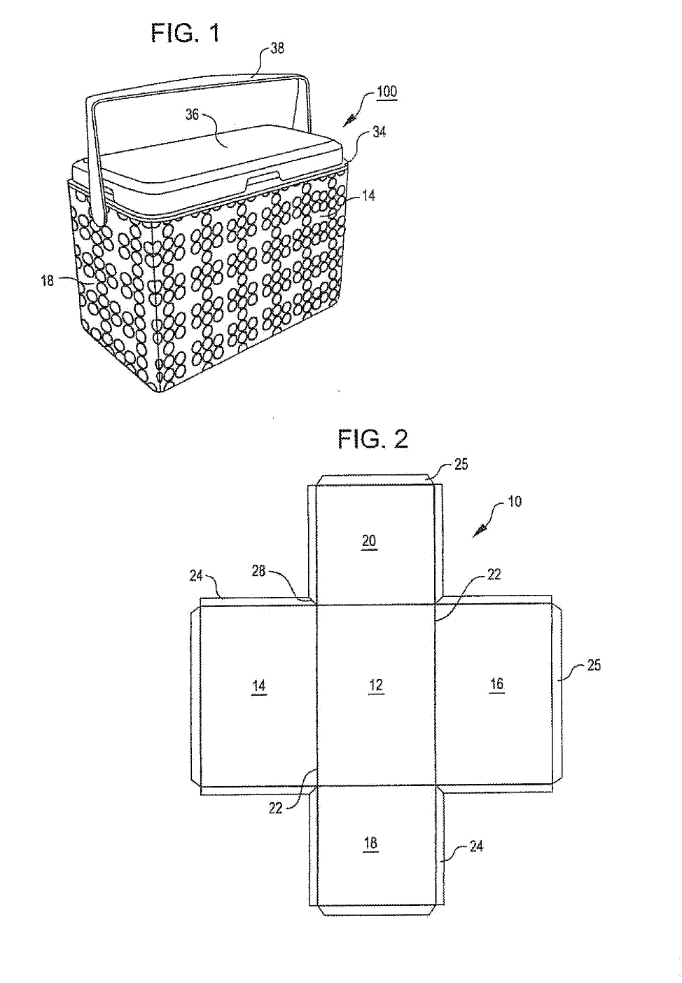

Referring now to the drawings, in which like reference numerals represent like parts throughout the several views, FIG. 2 shows a single sheet 10 of material in accordance with an embodiment. Sheet 10 is preferably high density polyethylene (HDPE), but may also comprise other materials known in the industry which are sufficiently rigid to provide structure to the container, yet sufficiently flexible to allow the sheet 10 to be folded along grooves, such as aluminum, thin steel, other metal, polypropylene, other plastics or the like. Sheet 10 is extruded to obtain the desired thickness and is then die cut into the pattern shown in FIG. 2. Sheet 10 is approximately 0.100 inches thick, but a thinner or thicker sheet of material is also within the scope of the present invention, depending on the specific material being used, the extruding machinery, and the desired thickness or weight of the assembled container 100, shown in FIG. 1. As shown in FIG. 2, once die cut, sheet 10 comprises a bottom panel 12, side panels 14, 16 and end panels 18, 20, all of which are ably generally rectangular in shape. The specific dimensions of the panels will vary depending on the capacity of the container that is contemplated. It should be noted that specific dimensions have generally been omitted from this description as the present invention is not limited to a specific size of container, but is applicable to a wide range of capacities and dimensions.

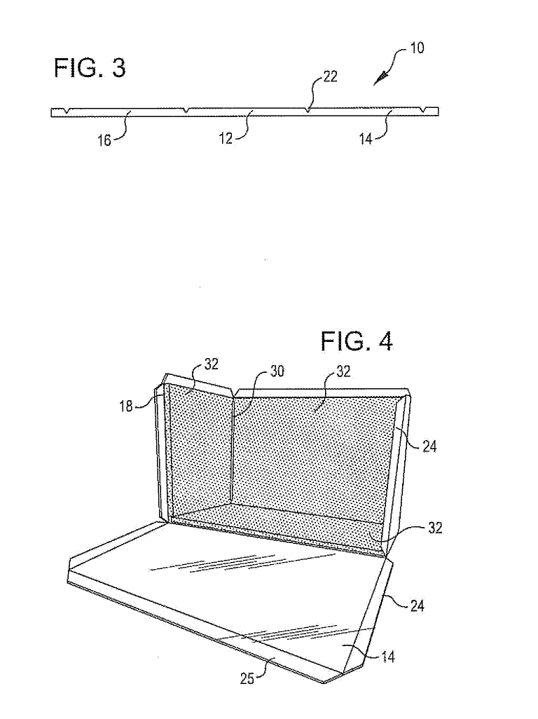

Fold grooves 22 separate bottom panel 12 and side panel 14 and also separate bottom panel 12 and side panel 16. Fold grooves 22 separate bottom panel 12 and end panel 18 and also separate bottom panel 12 and end panel 20. Fold grooves 22 are preferably heat stamped on the interior side of the sheet 10 to provide guidance in folding the corners of the cooler. It is also within the scope of the present invention, however, for a press to otherwise compress the grooves 22 into the sheet 10 during the die cutting process. Grooves 22 do not extend through the entire thickness of sheet 10 and do not dissect sheet 10. As shown in FIGS. 2 and 3, fold grooves 22 are generally linear and comprise a thinner section of the sheet 10 to enable the respective panels to be folded towards each other in a specific manner to form a container 100 having a bottom panel 12, side panels 14, 16, end panels 18, 20 and interior cavity 26. As shown in FIG. 3, fold grooves 22 preferably have a generally “V” shaped cross section to enable folding and also provide a natural stop so that the side panels 14, 16 and end panels 18, 20 are generally perpendicular to bottom panel 12 and do not fold too far inward. Sheet 10 preferably comprises four fold grooves extending the entire length of die cut sheet 10 from exterior edge of end panel 18 to exterior edge of end panel 20 and also from exterior edge of side panel 14 to exterior edge of side panel 16. It is also within the scope of the present invention for sheet 10 to comprise twelve fold grooves wherein the fold grooves separating side panels 14, 16 from fold flanges 24 and fold grooves separating end panels 18, 20 from fold flanges 24 are separate fold grooves from the fold grooves separating bottom panel 12 from the side panels 14, 16 and the end panels 18, 20. It is also within the scope of the present invention for grooves 22 to have a different cross section other than generally “V” shaped such as generally “U” shaped or other shape which allows the panels to fold.

As shown in FIG. 2, fold flanges 24 are located adjacent the die cut corner intersections 28 between end panels 18, 20 and side panels 14, 16. There are preferably 8 fold flanges 24 which enable the end panels and side panels to fold upward toward the interior of bottom panel 12 and remain secured. The edges of fold flanges 24 are preferably not connect to the adjacent fold flange located at the same intersection 28. Optional top flanges 25 are located on the top ends of end panels and side panels when the panels are in the assembled configuration. Top flanges 25 fold inward at the top of the cooler 100 to assist in securing the cooler 100 in the assembled configuration and to assist in maximizing the thermal properties of the cooler 100. Top flanges 25 are preferably the same thickness as sheet 10, but could be thinner if desired. The edges of top flanges 25 may be slightly tapered. Fold flanges 24 and top flanges 25 are preferably approximately inch wide, although other dimensions are within the scope of the present invention depending on the size of the sheet 10 needed for the desired fully assembled cooler dimensions.

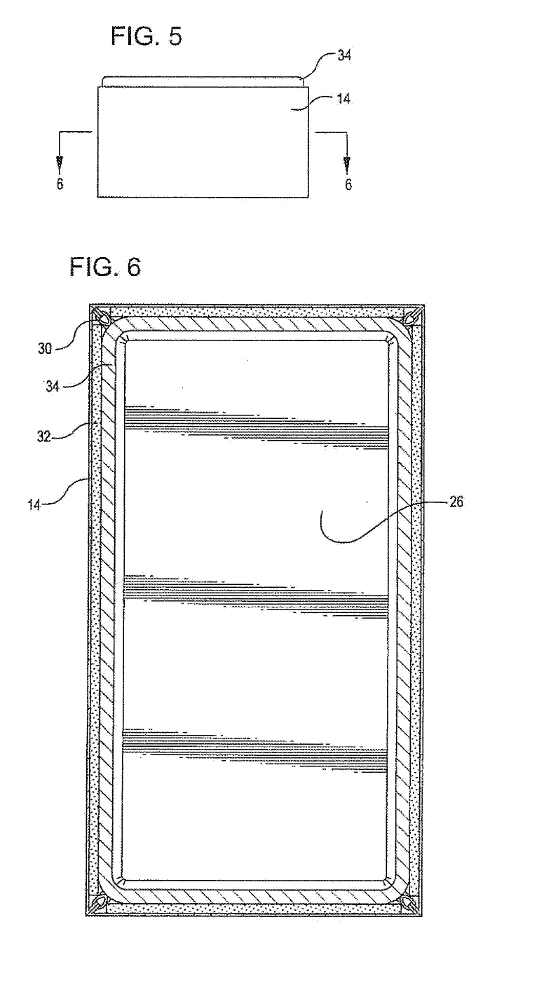

In operation, end panels 18, 20 and side panels 14, 16 are folded along fold grooves 22 in an inward and upward manner, as shown in FIG. 4. Fold flanges 24 are folded inward toward the top center of bottom panel 12 as the end panels and side panels are folded upward. Once adjacent fold flanges 24 are in an abutting configuration, clips 30 are fitted over the fold flange edges 31 to secure the cooler 100 in an assembled configuration, as shown in FIG. 5.

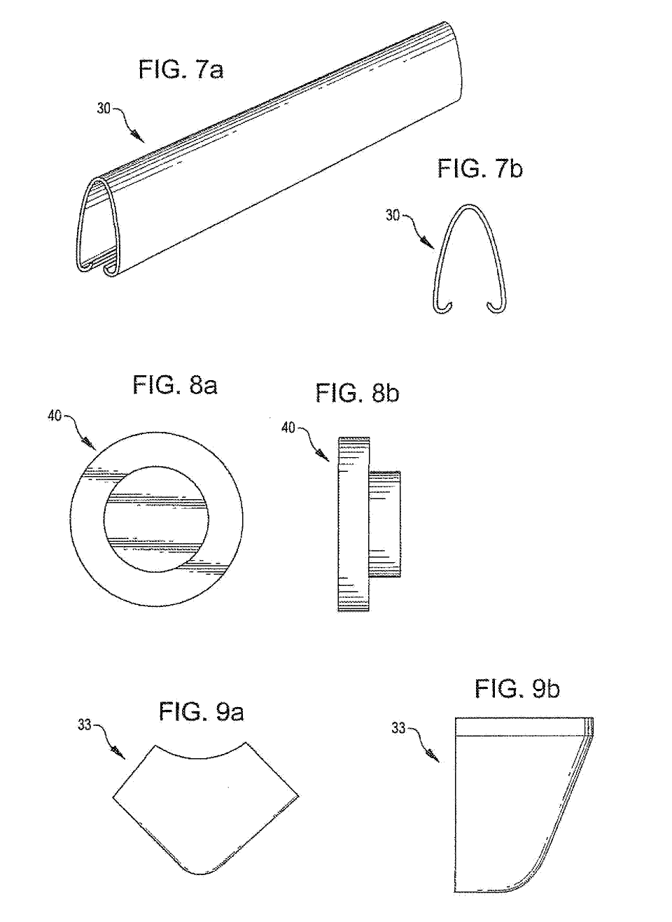

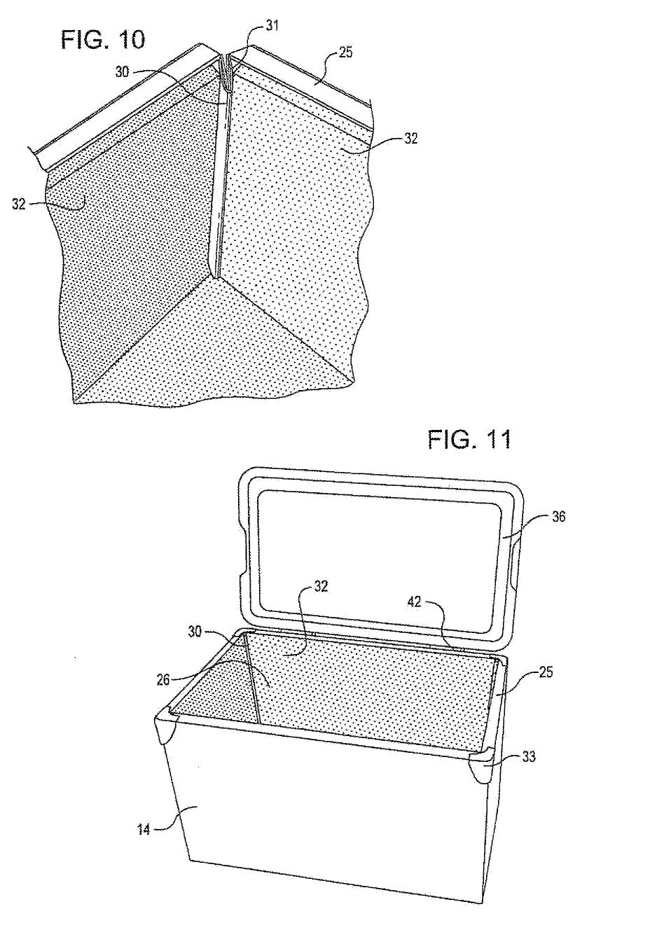

As shown in FIGS. 7 and 10, clip 30 is preferably generally “U” shaped to fit around fold flange edge 31, but may comprise other shapes that will operate to maintain adjacent fold flanges 24 into an abutted relationship with each other. Clip 30 is preferably slightly shorter in length than the interior depth of cooler 100 before the liner is inserted. It is within the scope of the present invention, however, for clips 30 to be shorter in length or to use multiple clips 30 at each intersection 28. Clip 30 is preferably extruded steel, but may also be made of stamped steel, plastic, aluminum or other flexible material which will provide sufficient tension in the clip. The pinch clip 30 is used to secure the fold flanges of the cooler to form the case body 21.

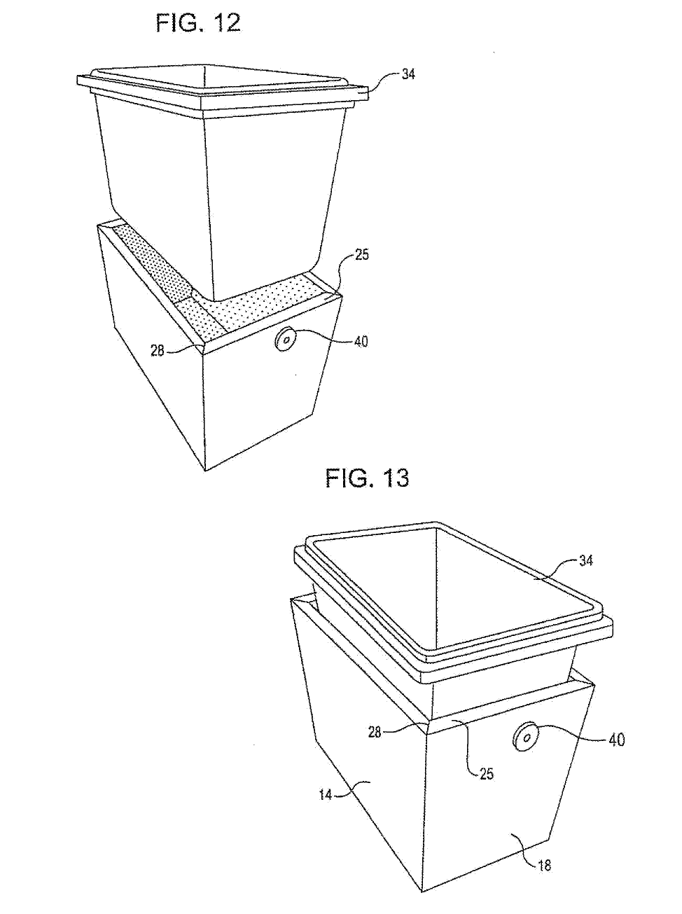

As shown in FIGS. 9 and 11, optional corner caps 33 can be added to the folded corners 28 to assist in retaining the end panels 18, 20 and side panels 14, 16 in the fully assembled configuration. Corner caps 33 are preferably plastic, but may also comprise rubber or other durable material. Corner caps 33 cover corner intersection 28 to assist in retaining the fully assembled configuration of cooler 100 and also to assist with weather-proofing and aesthetics. Corner caps 33 may abut liner 24 or may be covered by lip of liner 24. Corner caps 33 may be the same or different color and/or texture as the exterior of cooler 100, handle 38, lid 36 or any other feature of cooler 100. Similarly, all features of cooler 100 such as the handle, lid and the like may be made of different colors or comprise various textures to provide pleasing aesthetics. It is also within the scope of the present invention to contain folded corners 28 by means other than clips 30, such as rivets, screws, bolts, staples, adhesive and the like or to use any combination of such means. It is also within the scope of the present invention to use no means to secure the corners other than insertion of insulation and a liner. For example, the geometry of the liner itself may be used to secure the folded assembly.

A layer of insulation 32 is located adjacent the interior side of cooler body 21. Insulation 32 preferably comprises pre-molded foam such as Styrofoam, EPA insulation foam or fiber, as well as other insulation materials known in the industry. Insulation 32 is preferably adhered to the interior side of sheet 10 in five separate pieces to enable the unassembled cooler (i.e. the die cut sheet 10) to be stored flat for shipping and storage. As shown in FIGS. 3 and 4, insulation 32 is adhered to bottom panel 12, side panels 14, 16 and end panels 18, 20. The use of these sheets eliminates the need for ovens to cure the liquid urethane foam which is used in conventional hard-sided coolers. Various thicknesses and ratings for insulation may be used depending on the desired thermal capabilities of the finished cooler 100. Insulation 32 may be as thick or thicker than fold flanges 24 are deep, as shown in FIGS. 4, 5 and 11, to enable sheet 10 to be folded to form assembled cooler 100. It is also within the scope of the present invention to secure insulation 32 to liner 34 by or to simply place insulation 32 in between cooler body 21 and liner 34 without any adhesive. Insulation 32 may comprise a single sheet of material that is cut in a pattern corresponding to sheet 10, but in a slightly smaller dimension. It is also within the scope of the present invention to use urethane foam which is post-molded to the folding end panels and side panels or to use the conventional method for added urethane to hard-sided coolers.

Liner 34 is located adjacent the interior side of insulation 32. Liner 34 is preferably made of thermoformed HDPE and is water-tight. It is also within the scope of the present invention for liner 34 to be made of injection molded polypropylene or other materials commonly used in the industry. As shown in FIGS. 12 and 13, liner 34 is a single piece of materials which forms an insert and is inserted on the interior side of the insulation 32 and clips 30. Liner 34 has a lip 35 which extends slightly above the top edge of the case body 21. Liner 34 is preferably adhered to interior of insulation 32, but it is also within the scope of the present invention for liner 34 to merely be placed inside the interior of insulation 32 without adhesive, or for liner to snap into place. Liner 34 may be permanent or removable. It is also within the scope of the present invention for liner 34 to comprise a soft, flexible material such as vinyl or the like. It is also within the scope of the present invention for liner 34 itself to comprise the desired thermal properties such that a separate layer of insulation is not required.

The cooler of the present invention may also include a carry handle 38 and a lid 36. Such features are common to coolers and are known in the industry. For example, the handle 38 is preferably made of polypropylene or other plastics and is attached to each end panel 18, 20 using a handle button 40 which allows the handle 38 to pivot. It is also within the scope of the present invention for the handle 38 to be stamped or formed into the folding sheet. In general, handles and other features are well known to those in the art and will not be described in detail herein.

The lid 36 is preferably a rectangular piece of insulating material enclosed in a hard plastic shell. The lid 36 may be sized to fit snugly yet removably within the cooler body cavity 26 opening. As shown in FIG. 10, the lid 36 may also be hingedly attached to the back side of the cooler body by means of hinges. The lid 36 may have features common to coolers such as beverage holders (not shown), which are disk-shaped indentations with a diameter slightly larger than the diameter of a common beverage container, or a hand grip (not shown), which is an indentation in the edge of the lid 36 that facilitates gripping the lid 36.

The handle 38 and lid 36 are preferably attached to the cooler 100 after the insulation 32 and liner 34 have been added. Handle button 40 may be attached to end panels 18, 20 during the manufacturing process, after sheet 10 has been die cut. Once the insulation 32 and liner 34 have been added to the folded sheet 10, the handle 38 may be snapped into the handle button 40 and the lid 36 may be inserted into cavity 26. Of course, other handles known in the art are within the scope of the present invention and may be utilized, as can other lids which are known in the art. In an embodiment, if desired, the consumer may take the cooler 100 apart after use such that the cooler 100 may be stored in a flat configuration and re-assembled when use is desired.

In an embodiment of the present invention, as shown in FIG. 1, a graphic design is applied to the show side (exterior) of the cooler body. The particular graphic design does not form a part of the present invention, as any graphic design may be used, including but not limited to a favorite sports team, school, country, color, abstract pattern, photograph or the like.

In one embodiment, the sheet 10 is extruded to have a specific texture or color. A graphic design may also be overmolded onto the exterior of the sheet 10. In another embodiment, a vinyl graphic is applied to the sheet 10 while the sheet 10 is still in the flat configuration, either before or after the sheet 10 has been die cut.

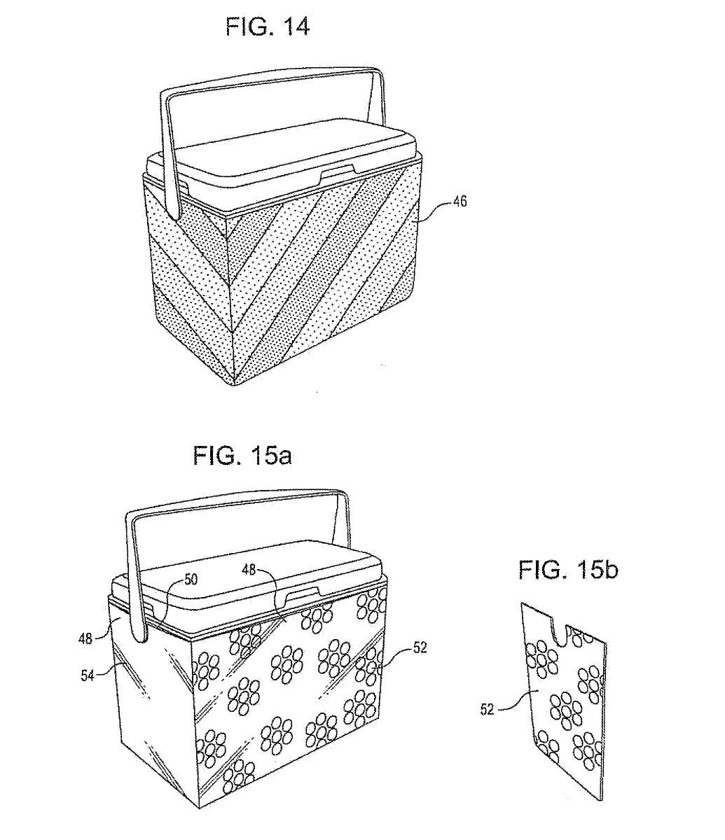

In an embodiment shown in FIG. 14, a graphic design skin 46 is provided that may be placed around the exterior of the cooler body. The graphic design may be printed or embossed onto the skin. The skin 46 is preferably made of vinyl or plastic and has some stretch or give in the skin 46 to enable a secure fit around the exterior of the cooler body 21. Materials other than vinyl or plastic are also within the scope of the present invention, provided they have sufficient elasticity as well as the ability to display a graphic design. For example, “shrink wrap” skins are also within the scope of the present invention and may be secured around the exterior of the cooler 100. Such a skin 46 can be removed by the user and replaced with a different skin or applied over the existing skin to enable the user to switch designs as desired.

In another embodiment, the container comprises sleeves 48 located on the exterior of the cooler body as shown in FIG. 15. Sleeves 48 have an opening at the top edge 50 of sleeve and receive graphic design inserts 52 within the interior cavity of sleeve 54. Sleeve 48 may or may not comprise means for closure to secure graphic insert 52 therein and maintain the insert 52 in a dry condition. Closure means may include plastic zippers, adhesive or the like. It is also within the scope of the present invention for any of the graphic design embodiment to be used with conventional hard-sided coolers.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An insulated container, comprising:
a flat sheet of material;
said sheet comprising grooves;
said sheet being folded along said grooves to form a cavity having a bottom wall and four side walls, each of said four side walls generally perpendicular to said bottom wall.

2. The insulated container of claim 1, further comprising insulation adjacent the interior of said cavity and a liner located adjacent the interior of said insulation.

3. The insulated container of claim 1, wherein said sheet of material comprises a single seamless sheet.

4. The insulated container of claim 1, wherein the material is high density polyethylene.

5. The insulated container of claim 1, further comprising a graphic design on the exterior of said cavity.

6. The insulated container of claim 1, further comprising sleeves located on the exterior of said cavity, said sleeves capable of receiving an insert having a graphic design thereon.

7. A method of manufacturing an insulated container using a flat sheet of material, comprising:
extruding a sheet of material;
cutting a pattern in said sheet of material, said pattern comprising a bottom panel, four side panels, and at least four fold guidelines; and
folding said four side panels upward along said at least four fold guidelines to form a cavity therein.

8. The method of claim 7, further comprising the step of embossing a graphic design on the exterior side of said sheet.

9. The method of claim 7, further comprising the steps of attaching a handle and a lid to said insulated container.

10. A method of assembling an insulated container, comprising:
folding a flat sheet of material along guidelines to form a configuration having a cavity therein;
inserting insulation adjacent the interior of said cavity; and
inserting a liner adjacent the interior of said insulation.

11. An insulated container, comprising:
a body having a bottom wall and four side walls forming a cavity therein, at least one of said four side walls displaying a graphic design.
